(19) United States
(12) Patent Application Publication
(10) Pub. No.: US 2020/0320851 A1
(43) Pub. Date: Oct. 8, 2020

(54) System and Method For Monitoring a Smart Home Device Medical Alert

(71) Applicant: Richard Deutsch, Gamer, NC (US)

(72) Inventor: Richard Deutsch, Gamer, NC (US)

(21) Appl. No.: 16/375,858

(22) Filed: Apr. 5, 2019

(51) Int. Cl. G08B 25/01; G08B 21/04; G10L 15/22; H04N 7/18; G06K 9/00

(52) U.S. Cl. CPC G08B 25/016; G08B 21/0446; G06K 9/00342; H04N 7/183; G06K 9/00771; G10L 15/22

(57) ABSTRACT

The present invention involves systems and methods for controlling one or more natural voice controlled smart home devices and services for the generation of a “HELP” push messages on a remote PDA/phone held by a caregiver thereby enabling the remote monitoring of a user's well-being. Activation of a system associated emergency “push button” by the user or the auto activation by a system associated physiologic sensor, or an accelerometer sensor affixed to the monitored user caused by rapid acceleration or deceleration of the user will cause the generation of a control signal activating an annunciator thereby indicating a possible fall or need for help and assistance. Through a cloud-based speech and voice recognition service, the natural user language interface will cause an audible or text push message to appear on a remote caregiver's PDA/phone device thereby indicating an occurrence of the monitored event and alerting the specified recipients.

### CROSS-REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR

Not Applicable

### BACKGROUND

Unless otherwise indicated herein, the materials described in this section are not prior art to the claims in this application and are not admitted to be prior art by inclusion in this section.

### 1. Field of the Invention

The present invention relates generally to a system or a method for monitoring the welfare of a person. More specifically, the present invention relates to a system or a method for activating a remote monitoring device.

### 2. Description of Related Art

Voice controlled devices and services have become ubiquitous with the introduction of voice activated Smart Digital Assistants also known as natural-language user interfaces, such as the Amazon Alexa, Echo, Echo Dot, Echo Show, Echo Spot, Nest, Siri, Sonos, Cortana, Google Home, Google Assistant, Simply Safe, Apple's Home Pod Home Kit, Vocca, Voice Pod, Ivee, At home Homey, Hal, Xiaomi Yee light and Jibo along with other voice activated systems. However, these devices have limited functions based on voice commands, such as answering questions from the internet, playing music, and reading audiobooks. Thus, these devices have limited use and are ineffective for many tasks. This makes them relatively expensive, because of the low return-on-investment. Therefore, there is a need for a system or method that has expanded uses, which are useful, effective, and inexpensive, so that they have a good return-on-investment.

### BRIEF SUMMARY OF THE INVENTION

It is a principal object to solve at least one of the disadvantages with other attempted solutions or to create other utility by providing a system or method that is useful, effective, inexpensive, or has a good return-on-investment.

The present invention involves a system or method for controlling one or more natural user language interfaces, which are natural voice controlled smart home devices with services for generating an audible or visual request. This request may summon help by way of at least one remote annunciator that may use either a color-coded flashing light, a digital or audio push message, or imaging on a remote electronic communications device or a combination of these. The remote electronic communications device may be a PDA, phone, iPad, tablet, or a similar device. In this way, it is possible for a caregiver or third party to remotely monitor a user's well-being. The present application defines the term “user” as the person seeking help, and the terms “third party” and “caregiver” as the persons providing help to the “user”.

The present invention also involves activation of a system by other devices or methods. One such device may be an associated emergency “push button” for the user to summon help. Another device may be by the auto activation of a system with an associated motion detector, accelerometer, or proximity sensor that is affixed to the monitored user. If a rapid acceleration or deceleration of the user is sensed, the device will generate a control signal indicating a possible fall or a need for help or assistance. The control signal is functionally associated with the generation of a pre-recorded audio message or text string, which is coupled to at least one natural-language user interface also known as a smart home device speaker. Through a cloud-based speech and voice recognition service, the natural-language user interface will cause a notification such as an audible, visual, or text push message to be transmitted to and appear on an electronic communications device, such as a PDA, phone, tablet, or iPad that is remotely monitoring the user, or by illuminating an attention grabbing color coded external lighting fixture thereby indicating an occurrence of the monitored event and alerting the anticipated recipients of such an occurrence.

Purposeful or automatic activation of the medical alert sensor may cause a signal to be wirelessly transmitted by a controller to a receiver and audio generator directly or indirectly associated with the voice actuated wide smart home device. Such actuation causes the smart home device to connect with a cloud-based web server through the smart home device. This initiates one or more program routines, which may include, annunciator activation, push messaging, or video imaging associated with the smart home devices pre-programmed functions or a combination of all of these.

### BRIEF DESCRIPTION OF THE DRAWINGS

The accompanying drawings, which are incorporated in and constitute a part of this specification, illustrate several aspects described below.

FIG. 1 is a diagram showing a specially configured smart watch, an optional modem (aka radio receiver), an Echo Dot, a Wi-Fi router, a light bulb, a light bulb controller base, a camera, a user, Standard Communication Services, a Cloud Notification Push Server, a Cloud Speech/Voice Recognition Service, a User Webpage Data Access Dashboard, and a smart phone in which at least one of the embodiments of the present invention is shown.

FIG. 2 is flowchart of the present invention showing a detection wristband, which connects to a Wi-Fi/smart device, which connects to a Server/Cloud Service in which at least one of the embodiments of the present invention is shown.

FIG. 3 is a diagram showing an Echo Dot, a speaker, a modem (aka radio receiver), and an Alexa voice device in which at least one of the embodiments of the present invention is shown.

FIG. 4 is a screen shot of a Tellalert Emergency Assistant dashboard in which at least one of the embodiments of the present invention is shown.

FIG. 5 shows a pendant configured with a “Help” button that is typically worn around a person's neck, an optional modem (radio receiver), an Echo Dot, a Wi-Fi router, Standard Communication Services, a Cloud Notification Push Server, a Cloud Speech/Voice Recognition Service, a User Webpage Data Access Dashboard, a light bulb, a light bulb controller, and a smart phone in which at least one of the embodiments of the present invention is shown.

FIG. 6 is flowchart of the present invention showing an Emergency Pendant, which connects to a Wi-Fi/smart device, which connects to a Server/Cloud Service in which at least one of the embodiments of the present invention is shown.

FIG. 7 is a diagrammatic representation of the implementation of a system controlled illumination of a color controlled flashing lamp in an externally located light fixture whose activation may be used to summon outside assistance when activated by the emergency button in which at least one of the embodiments of the present invention is shown.

### DETAILED DESCRIPTION OF THE INVENTION

It is to be understood that this invention is not limited to any particular embodiment described, which may vary. Also, it is to be understood that the terminology used herein is for the purpose of describing particular embodiments only, and is not intended to be limiting, since the scope of this invention will be limited only by the appended claims.

In the following detailed description, numerous specific details are set forth in order to explain and provide a thorough understanding of the present invention. However, it is apparent that the present invention may be practiced without some of these specific details. Thus, all illustrations of the drawings are for the purpose of describing versions of the present invention, and are not intended to limit the scope of the invention.

In the following section, the present invention is described fully by referencing the details in the enclosed drawings, which illustrate certain embodiments of the invention. The numbers shown in this specification refer to the corresponding numbers in the enclosed drawings. The terminology used is to describe the particular embodiment shown and is not intended to limit the scope of the invention. The invention may also be embodied in many other forms in addition to the embodiments shown. Thus, the embodiments shown should not be construed as limiting, but rather, to allow a thorough and complete description of the disclosure that conveys the scope of the invention to a person having ordinary skill in the art in the field of this invention. Therefore, for the terms used herein, the singular forms “the,” “a,” and “an” are intended to include the plural forms as well as the singular forms, unless the context clearly indicates otherwise. The term “and” includes any and all combinations of one or more of the associated listed items. As used herein, the terms “comprising” and “comprises” when used in this specification, identify specific steps, integers, operations, features, components, and elements, but do not preclude the presence or addition of one or more other steps, operations, features, components, and elements. In addition, the features, components, and elements referenced may be exaggerated for clarity.

Unless otherwise defined, all scientific terms, technical terms, or other terms used herein have the same meaning as the term that is understood by one having ordinary skill in the art in the field of this invention. It is also understood that these terms, including their dictionary meaning, should be understood as having the meaning, which is consistent with their definitions in the related relevant art. In addition, the present disclosure is not to be interpreted in an idealized or overly formal sense unless expressly stated so herein. Constructions or functions that are well known in the art may not be fully described in detail for brevity.

In describing the invention, it is understood that a number of steps and methods may be disclosed. Each of these may have individual benefit. Also, each may be used in conjunction with at least one or more of the disclosed steps and methods. Therefore, this description will refrain from stating each and every possible combination of the individual steps and methods for the sake of brevity. Regardless, the specification and related claims should be understood with the combinations that are entirely within the scope of the claims and inventions.

The disclosure in this invention are examples of how it may be implemented and are not intended to limit the scope of the invention to the specific embodiments shown in the accompanying drawings or the description provided herein. The present invention will now be described by example in the following paragraphs by referencing the accompanying drawings, which represent embodiments and alternative embodiments.

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

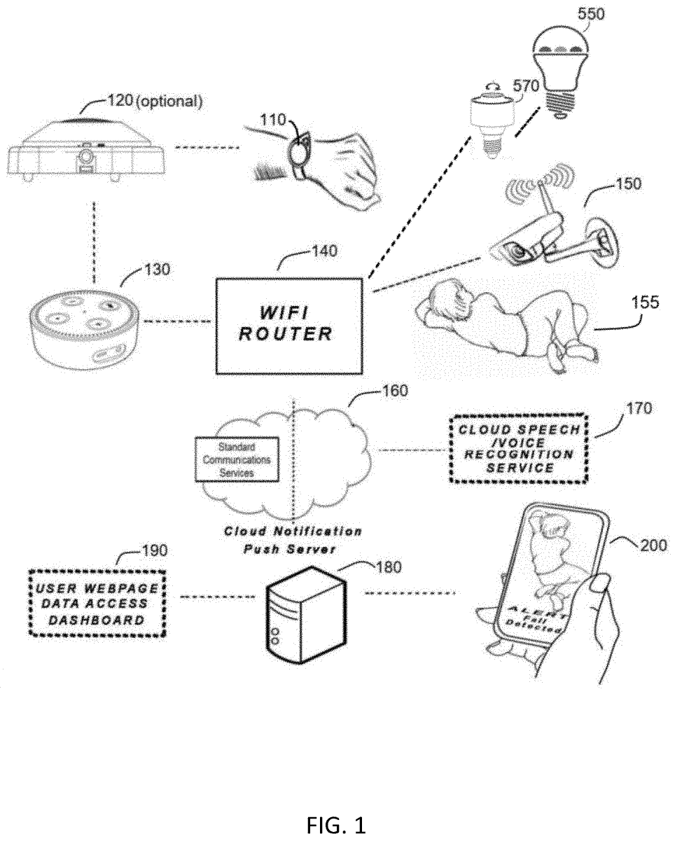

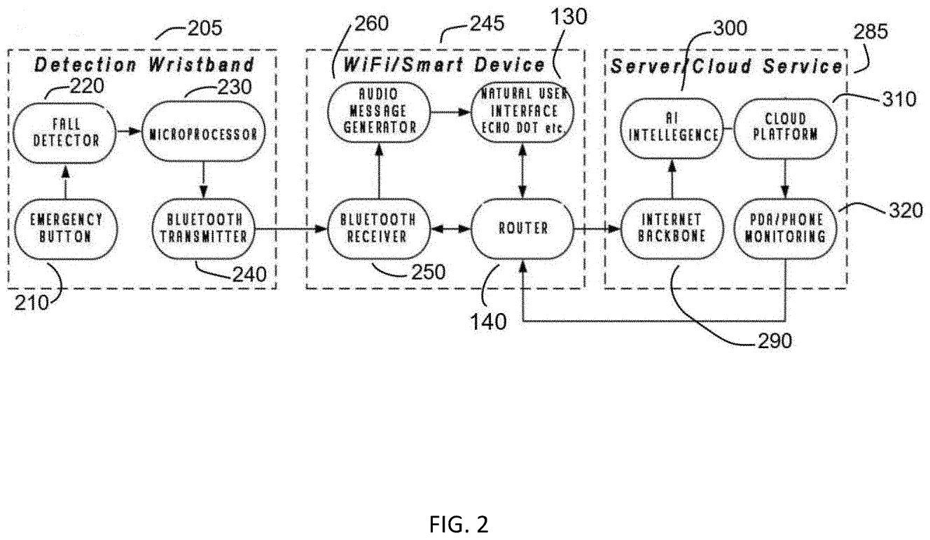

FIG. 1 is a diagram showing the invention, which comprises a user summoning radio transmitter such as a specially modified smart watch 110 and at least one optional separate (radio receiver) modem 120. During his every day activities, the user 155 may wear the specially configured smart watch 110, which is sometimes referred to herein and in FIG. 2 as a detection wristband 205. The smart watch 110 or detection wristband 205 may comprise at least one user actuator or emergency “Help” button.

FIG. 1 also shows that the invention comprises at least one natural-language user interface (NLUI) such as an Echo Dot 130, at least one Wi-Fi router 140, at least one camera 150 to identify the position of a user 155, at least one Standard Communication Services 160, at least one Cloud Speech/Voice Recognition Service 170, at least one Cloud Notification Push Server 180, at least one display comprising a User Webpage Data Access Dashboard 190, and at least one electronic communications device such as a specially programmed smart phone 200 in which at least one of the embodiments of the present invention is shown. In addition, FIG. 1 shows a potentially unicolor or configurable multicolor light bulb (also known as a lamp) 550 capable of flashing in alternate colors, which screws into a radio accessible light bulb controller 570 in which at least one of the embodiments of the present invention is shown.

FIG. 2 is flowchart of the present invention showing at least one detection wristband 205, which connects to at least one Wi-Fi/smart device 245, which connects to at least one Server/Cloud Service 285.

As shown in FIG. 2, at least one detection wristband 205 is specially configured to comprise at least one emergency button 210, at least one fall detector 220, at least one microprocessor 230, at least one wireless transmitter 240, and at least one non-transitory computer readable medium. Also, as shown in FIG. 2, the at least one Wi-Fi/smart device 245 is specially configured to comprise at least one Bluetooth receiver 250, at least one Audio Message Generator 260, at least one natural-language user interface 130, such as the Amazon Alexa, Echo, Echo Dot, Echo Show, Echo Spot, Nest, Siri, Sonos, Cortana, Google Home, Google Assistant, Simply Safe, Apple's Home Pod Home Kit, Vocca, Voice Pod, Ivee, At home Homey, Hal, Xiaomi Yee light and Jibo along with other voice activated systems; and at least one router 140. In addition, as shown in FIG. 2, the at least one Server/Cloud Service 285 comprises at least one Internet Backbone 290, at least one AI Intelligence 300, at least one Cloud Platform 310, and at least one PDA/phone Monitoring 320.

As shown in FIGS. 1 and 2, the specially configured smart watch 110 is often referred to as a detection wristband 205 especially when it is configured to comprise at least one emergency button 210, at least one fall detector 220, at least one microprocessor 230, at least one wireless transmitter 240, and at least one non-transitory computer readable medium. The user 155 wears the detection wristband 205 during his every day activities.

In at least one embodiment of the present invention, the smart watch 110 on the detection wristband 205 may comprise an accelerometer or altimeter. or proximity sensor. A rapid downward acceleration of the smart watch 110 followed by an abrupt deceleration of the smart watch 110 worn by user 155 may be recorded by the Fall Detector 220 and interpreted by a specially programmed microprocessor 230 as the user 155 falling and striking the floor or ground. The microprocessor 230 is specially programmed to detect movements that signal the user 155 may be in danger or in need of assistance. The microprocessor 230 may then transit a signal via a wireless transmitter 240, such as a Bluetooth Transmitter, Wi-Fi, GSM, LTE, NFC, or ISM wireless frequency. The signal may then be transmitted via a modem in the smart watch 110 or a separate (radio receiver) modem 120, to an Echo Dot 130, and then to a Wi-Fi router 140. Transmitting the signal may allow the Wi-Fi router 140 to remotely activate a camera 150 imaging user 155 and send a still or video image to a Cloud Notification Push Server 180, which may transfer the information to a User Webpage Data Access Dashboard 190 and a smart phone 200 or both. The smart phone 200 may be maintained by a caregiver or other person capable of supplying or calling for further assistance. Also, the Echo Dot 130 may detect a user's voice or call for assistance, which will be sent to the Wi-Fi router 140, interpreted through the Cloud Speech/Voice Recognition Service 170, converted to a text string, and then communicated via the Standard Communication Services 160 and the Cloud Notification Push Server 180 to a caregiver with a smart phone 200.

If such a scenario occurs, as shown in FIG. 2, the detection wristband 205 may first alert the user 155 through an audio, visual, or sensory signal (such as a vibration) that the detection wristband 205 has sensed that the user 155 may be in need of assistance and begin a timer for the user 155 to respond. An audio alert may commence with the start of the timer indicating the timed opportunity to cancel the remote notification has started. This will allow the user 155 a predetermine amount of time to cancel the “Help” signal before it is transmitted to others for assistance. For example, the detection wristband 205 may be preprogrammed to allow the user 155 to have about one minute to enter a keypress into the detection wristband 205 to cancel the call for help. If the required cancellation keypress is not entered, the detection wristband 205 will transmit a wireless help signal thereby activating the modem. This could be useful if the user 155 was performing an activity that may falsely simulate the user 155 falling. For example, if a user 155 chops food with a knife, his wrist will initially rapidly accelerate downwards and then abruptly decelerate when the knife chops through the food and hits the chopping block. The detection wristband 205 may falsely determine that this downward acceleration of the smart watch 110 followed by its abrupt deceleration is a signal that the user 155 has fallen. Thus, to guard against such false signals, the detection wristband 205 may comprise an option to prevent transmission of a signal to a caregiver by allowing the user 155 to enter a key press or passcode into the detection wristband 205 to deactivate the signal and the call for help. If the transmission of the signal is not deactivated by the user 155, then it is transmitted by the user's emergency calling device. Also, in at least one embodiment of the present invention, the user 155 may first turn off the signal, if the user 155 knows that he will engage in an activity, such as chopping food, that may generate a false alarm.

The movement of the detection wristband 205 is carefully scrutinized by the microprocessor 230 to avoid a false signal. The detection wristband 205 is also programmed to detect other movement patterns that may indicate that the user 155 is in need of assistance. For example, in at least one embodiment of the present invention, if the microprocessor 230 records the smart watch 110 moving at a constant horizontal velocity followed by an abrupt deceleration, then the microprocessor 230 may assume that the user 155 was walking, running, biking, driving, etc. and then struck a stationary object. However, the user 155 may have rapidly stopped and was unharmed. In such an instance, the user 155 may be alerted that the detection wristband 205 was activated and will send a distress signal unless a keypress or passcode is entered to de-activate transmission of request for help.

In at least one embodiment of the present invention, the detection wristband 205 may incorporate a sensor such as a fall detector 220 and a microprocessor 230. The microprocessor 230 may then take numerous readings from the sensor on an ongoing basis to establish a baseline reading. The microprocessor 230 may also monitor other signals from the detection wristband 205 to determine if the signals indicate that the user 155 is in danger, such as a change in temperature, heartrate, pulse oximetry or other health related parameters indicating physiologic stress.

In at least one embodiment of the present invention, the microprocessor 230 in the detection wristband 205 may send an alert signal if it detects a rapid change in the proximity to the floor of the detection wristband 205, which may be associated with the user 155 falling. If this occurs, the microprocessor 230 may send a signal, unless it is canceled.

In at least one embodiment of the present invention, the microprocessor 230 in the detection wristband 205 may send an alert signal if it detects that the temperature is too cold or too hot. If the temperature is too cold, the detection wristband 205 may send a signal in case the heating system of the user's home 155 is broken. If the temperature is too hot, the detection wristband 205 may send a signal in case the user's air conditioning system is broken or if there is a fire.

In at least one embodiment of the present invention, the microprocessor 230 in the detection wristband 205 may send an alert signal if the associated sensor detects that the user's heartrate, blood oxygenation, blood pressure, body temperature, or any other health monitor measured by the detection wristband 205 is outside of a normal range.

In at least yet one more embodiment of the present invention, the microprocessor 230 along with an accelerometer or fall detector 220 in the detection wristband 205 may be used to detect a change in the cadence or arm swing of the user 155. The detection wristband 205 may be either pre-programmed to learn the typical arm swing of the user 155 or to measure when the user 155 first begins to wear the detection wristband 205. If the user 155 is injured and begins to walk with a limp, then his arm swing may change and the microprocessor 230 may send a signal to a smart phone 200 of the third party or caregiver. However, the user 155 may receive an alert before this signal is sent in case the user is not injured. For example, the user 155 may receive an alert if his arm swing changes, because he is carrying a heavy object in one hand. In this case, the user may enter a code or press a keypress on the detection wristband 205 to prevent the signal from being sent, since he is not injured.

In at least yet one embodiment of the present invention, the smart watch 110 may send an initial signal as soon as an abnormal movement occurs. The smart watch 110 may then send an additional signal if the user 155 cancels the alert. In such a situation, a third party will receive the alert and additional information on whether or not to respond. For example, this additional information may include heart rate, body temperature, and air temperature surrounding the user 155, GPS location, and GPS movements. For example, the user 155 may slip and fall. However, the user 155 may underestimate the extent of their injuries and cancel the call for help, believing that they are not in danger. However, if they are injured and cannot move from where they have fallen, the third party may receive the GPS readings and an interpretation of these as determined by the microprocessor 230 to send out a message with the user's GPS coordinates to his or her emergency contacts selected and shown in the Emergency Assistant Dashboard 190. For example, a rapid downward acceleration, followed by an abrupt deceleration, followed by little or no movement from the GPS readings may signal that the user 155 has fallen and is injured, and cannot move at all or can only move slightly. Additionally, sensors may be incorporated into the detection wristband 205 to give a machine-learning artificial intelligence (AI) backend a bigger dataset to work with, reducing the number of false positives. The dataset may be stored on at least one non-transitory computer-readable medium that comprises computer storage media and communication media including any medium that facilitates transfer of a computer program or data from one place to another. Thus, even if the user 155 canceled the signal for help, a third party may still be informed of the pre-signal, the cancellation, and the lack of movement afterwards. The microprocessor 230 may then transmit a message to the third party advising whether they should immediately respond, thereby causing the respondent to call the user 155 by telephone, remotely access monitoring at least one video imaging camera 150 of the user 155 or continue to monitor the situation.

The user 155 may also activate an emergency button 210 if they need assistance and the smart watch 110 did not automatically alert a third party responder.

As described in the examples and embodiments discussed above and as shown in FIG. 2, the detection wristband 205 is specially configured with a microprocessor 230 to detect if a user 155 is in need of assistance. This detection may occur by the user's activation of an emergency button 210 or the automatic generation of a fall detector 220 signal. A signal may be automatically generated through a detection wristband 205 that interprets the results of movement of an accelerometer, temperature sensor, heartrate monitor, another health monitoring device, or a combination of these to transmit a signal via a wireless means 240.

The system and method for controlling one or more natural voice controlled smart home devices and services for the generation of a “HELP” type push message on a remote

PDA/phone thereby enabling a caregiver to remotely monitor a user's well-being. Activation of a system associated emergency “push button” by the user 155 or the auto activation of a system associate accelerometer or physiologic sensor affixed to the monitored user 155 caused by rapid acceleration or deceleration of the user 155 will cause the generation of a control signal indicating a possible fall or need for help and assistance. This control signal is functionally associated with the generation of a pre-recorded audio or text string message, which is acoustically or electronically coupled directly, or indirectly through a modem to a natural-language user interface 130 that is commonly referred to as a smart home device speaker. Through a cloud-based speech and voice recognition service 170, the natural user language interface 130 will cause an audible or text push message to appear on a remote caregiver's PDA/phone device 200 thereby indicating an occurrence of the monitored event and alerting the specified recipient or recipients.

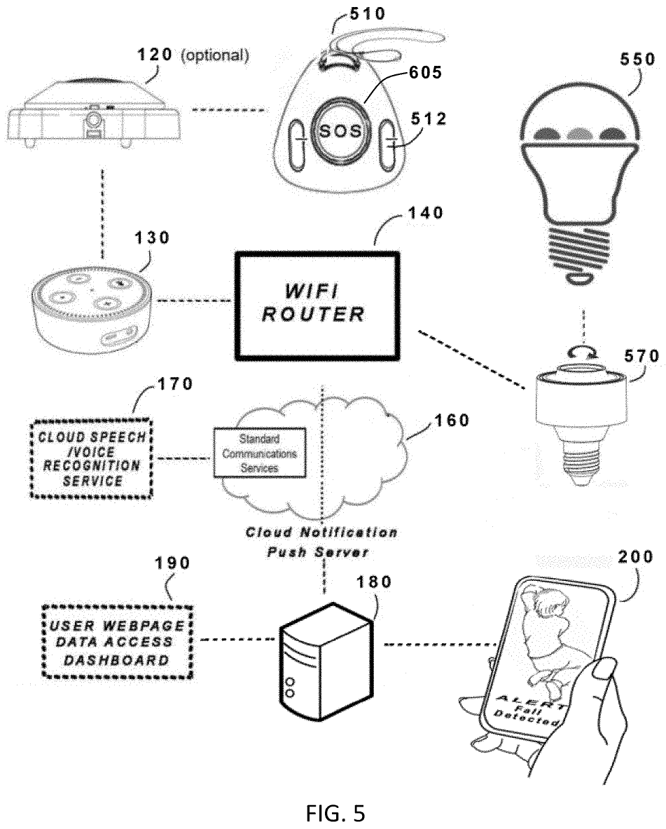

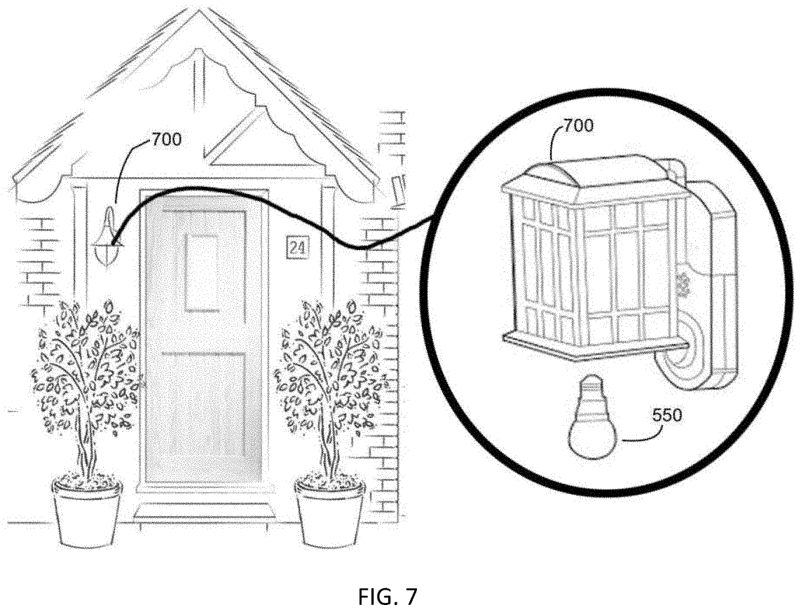

The processor 230 within a smart watch 110, detection wristband 205, or similar pendant 510, as shown in FIG. 5, may be actuated manually or automatically. This will cause the generation of one or more distinct push messages and transducer activations directly relating to the distinct reason, cause, or circumstances of actuation. For example, one push message may be read “Please call me” as a minor request for assistance, while an integral accelerometer may cause the generation of a more urgent “I have fallen” message. Alternately, the manual activation by a user 155 may cause another, more-dire message request to read “Please contact emergency services NOW!” Additionally, there may be a concomitant remote activation of a multicolored flashing light 550 via bulb controller 570, as shown in FIG. 5, which is installed external to the residence to assist emergency workers in locating the home of the user 155 requiring assistance, as shown in FIG. 7.

Purposeful or automatic activation of the at least one medical alert sensor, such as a smart watch 110, detection wristband 205, or similar pendant 510 may cause a signal to be wirelessly transmitted by a controller to a wireless receiver incorporating an audio generator or text string directly or indirectly associated with the voice actuated wide smart home device 130. Such actuation causes the smart home device 130 to connect with a cloud-based web server thereby initiating one or more program routines to include automated video imaging of the subject associated with the pre-programmed functions of the smart home devices.

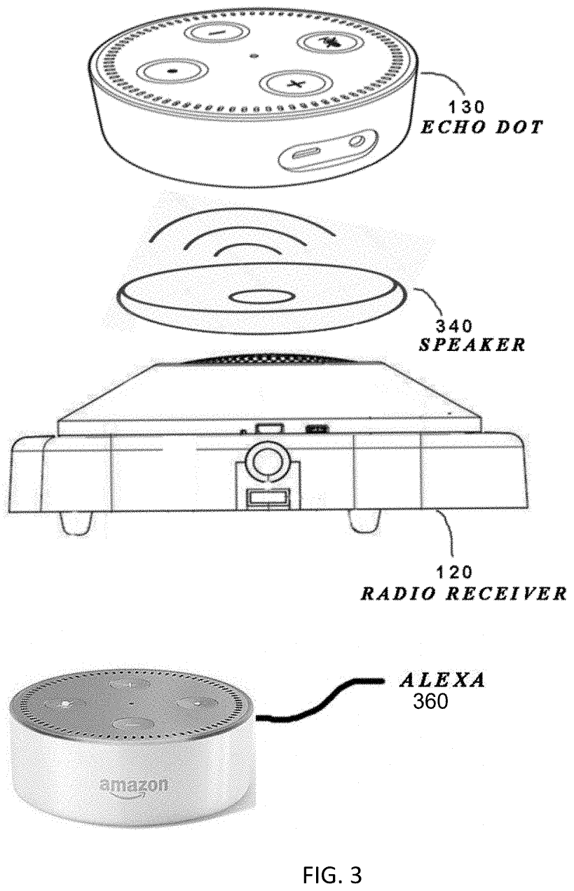

FIG. 3 is a diagram showing an Echo Dot 130, a speaker 340, an optional modem (aka radio receiver) 120, and an Alexa Virtual Assistant device 360 (or similar) in which at least one of the embodiments of the present invention is shown. As shown in FIG. 3, the Echo Dot 130 and Alexa 360 are types of natural-language user interfaces (NLUI). FIG. 3 also shows the Echo Dot 130 associating with a speaker 340 that connects to 340 a modem (radio receiver) 120.

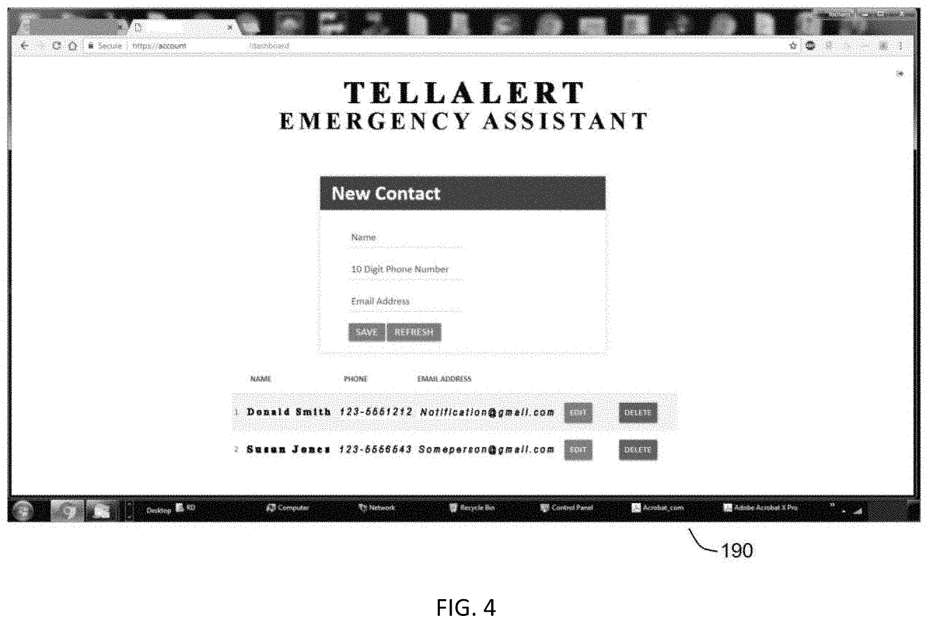

FIG. 4 is a screen shot of a user webpage data access dashboard 190 with the title “Tellalert Emergency Assistant”. This system associated user or caretaker programmable webpage provides the caretaker or user the means by which to remotely select those persons to receive a request for assistance when manually or automatically requested in which at least one of the embodiments of the present invention is shown.

FIG. 5 is an alternative embodiment of the present invention that involves the use of a pendant 510 with at least one auxiliary message function button 512, and at least one emergency call “Help” button 605 using the systems and methods of this invention rather than a detection wristband 205 or a smart watch 110. The pendant 510 has an emergency call button 605 configured as a “Help” emergency pendant 510 incorporating the monitoring capabilities of the “Smart Watch” illustrated above. The user 155 may wear the pendant 510 during his every day activities. In at least one other embodiment, the detection wristband 205 or pendant 510 may take the form of a ring, ear piece, earring, belt buckle, etc.

As shown in FIG. 5, the pendant 510 is typically worn around a person's neck, which operates with an optional modem (radio receiver) 120, an Echo Dot 130, a Wi-Fi router 140, Standard Communication Services 160, a Cloud Notification Push Server 180, a Cloud Speech/Voice Recognition Service 170, a User/Caretaker Webpage Data Access Dashboard 190, and a potentially flashing unicolor or configurable multicolor light bulb 550 whose operation is controlled by a wireless receiver incorporated into bulb controller 570 in which at least one of the embodiments of the present invention is shown. It should be understood under certain configurations, the communication link between the smart watch 110, detection wristband 205, or similar pendant 510 may be achieved by wireless direct communication with the natural-language user interface Echo like device 130 without the modem 120.

Also as shown in FIG. 5, the lamp controller 570, which may be co-located with an LED lamp to activate and flash an LED lamp 550, may garner passerby attention, as shown in FIG. 7, or summon medical personnel by causing the lamp to display one or more red, green or blue colors. The colors of these lights may also be coordinated to reflect the specific type of emergency indicated by the user or that was remotely activated through the function of the smart watch 110, detection wristband 205, or similar pendant 510.

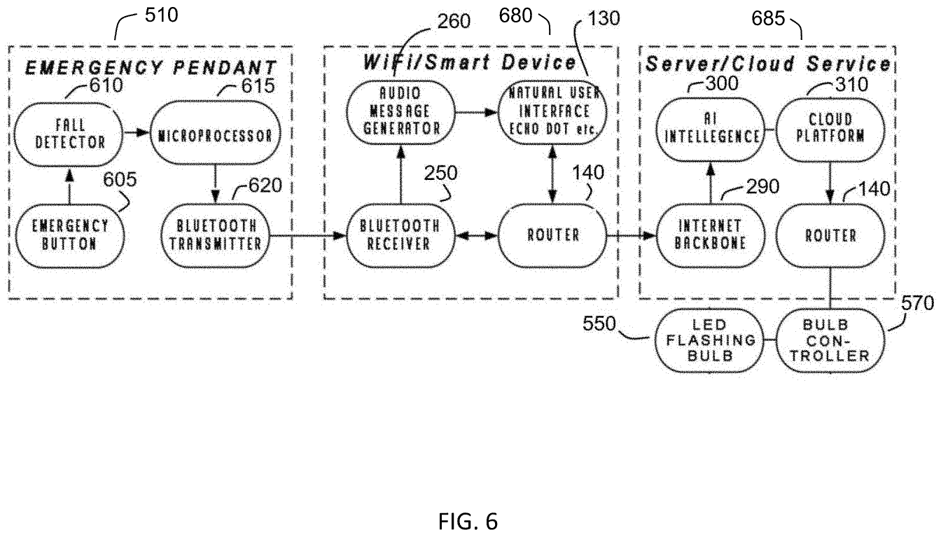

FIG. 6 is flowchart of the present invention, which in part shows an Emergency Pendant 510, a Wi-Fi/smart device 680, and a Server/Cloud Service 685. The Detection Call Pendant 510 comprises an emergency button 605, a fall detector 610, a microprocessor 615, and a radio/Bluetooth Transmitter 620. The flowchart of FIG. 6 shows that the Wi-Fi/smart device 680, comprises a Bluetooth/radio receiver 250, a Text String/Audio Message Generator 260, a natural user language interface (i.e. Echo Dot, etc.) 130, and a router 140. The flowchart of FIG. 6 also shows the Server/Cloud Service 685, which comprises an Internet Backbone 290, AI Intelligence 300, at least one Cloud Platform 310, and at least one router 140 that connects to a potentially flashing unicolor or configurable multicolor lamp (also known as a light bulb) 550, which screws into a light bulb controller base 570.

FIG. 7 is a diagrammatic representation of the implementation of a system-controlled illumination of a remotely controlled flashing RBG multicolor lamp 550 housed within an externally located light fixture 700 whose activation may be used to summon outside assistance when activated by the emergency button in which at least one of the embodiments of the present invention is shown.

In at least one embodiment, the functions of the device or method described may be implemented in software, firmware, hardware, or any combination thereof. When implemented in software, the functions may be transmitted, as one or more instructions or code on, over or stored on at least one computer-readable medium. The computer-readable media may include both communication media and computer storage media, including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

The method comprises receiving data from a specialized communication device, over a cellular, wireless, satellite, or other network to a special purpose computer with a non-transitory computer readable medium. In one or more of the embodiments, the functions described herein may be implemented in any combination of hardware, software, firmware, etc. The functions may be stored or transmitted as one or more software instructions, computer-executable instructions, or processor-executable instructions, or code on a tangible non-transitory computer readable medium or on a non-transitory processor-readable storage medium, if implemented in software. The steps of an algorithm, process, or method disclosed herein may be embodied in a processor-executable software module that may reside on a non-transitory computer readable medium. Non-transitory computer readable medium readable media comprises computer storage media and communication media including any medium that facilitates transfer of a computer program from one place to another. A non-transitory storage media may be any available media that may be accessed by the special purpose host computer system.

Also, combinations of the above should be included within the scope of non-transitory computer readable medium. In addition, the operations of an algorithm, process, or method may reside as one or any combination or codes, set of codes, instructions, or sets of instructions on a non-transitory machine readable medium, which may be incorporated into a computer program product. By way of an example, and not as a limitation, a non-transitory computer readable medium may comprise Random-Access Memory (RAM), Read-Only Memory (ROM),

Also, combinations of the above should be included within the scope of non-transitory computer readable medium. In addition, the operations of an algorithm, process, or method may reside as one or any combination or codes, set of codes, instructions, or sets of instructions on a non-transitory machine readable medium or an a non-transitory computer readable medium, which may be incorporated into a computer program product. All illustrations of the drawings are for the purpose of describing selected versions of the present invention and are not intended to limit the scope of the present invention.

All of these embodiments and the invention disclosed herein are intended to be within the scope herein disclosed. These and other embodiments of the invention will become readily apparent to those skilled in the art from the detailed description of the preferred embodiments having reference to the attached figures, the embodiments not being limited to any particular, preferred embodiments disclosed. Also, the invention disclosed herein suitably may be practiced in the absence of any element which is not specifically disclosed herein.

While certain embodiments have been shown and described, it will be understood that there is no intent to limit the invention by such disclosure, but rather, is intended to cover all modifications and alternate constructions falling within the spirit and scope of the invention as defined in the appended claims.

Although the invention has been explained in relation to its preferred embodiment, it is to be understood that many other possible modifications and variations may be made without departing from the spirit and scope of the invention.

1. A system for monitoring a smart home device medical alert comprising:
a. a user summoning radio transmitter;
b. at least one natural-language user interface (NLUI);
c. at least one Wi-Fi router;
d. at least one Standard Communication Services;
e. at least one Cloud Speech/Voice Recognition Service;
f. at least one Cloud Notification Push Server, and
g. at least one system associated remote annunciator selected from the group consisting of a remotely controlled color coded flashing light, which is coordinated to reflect the specific type of emergency and housed within an externally located light fixture to garner passerby attention or summon medical personnel, a digital push message on at least one electronic communications device, and an audio push message on at least one electronic communications device.

2. The system of claim 1, further comprising at least one system associated camera capable of viewing a user and whose imaging can be viewed on a remote device.

3. The system of claim 2, further comprising at least one specially programmed smart phone capable of viewing the user through the system associated camera capable of directly or indirectly communicating those images with a caretaker.

4. The system of claim 1, further comprising at least one user actuator button.

5. The system of claim 1, further comprising at least one modem.

6. The system of claim 1, wherein the user summoning radio transmitter comprises a detection wristband, comprised from a specially modified smart watch;
a. at least one an emergency “Help” button,
b. a temperature sensor,
c. a heartrate monitor,
d. at least one detector,
e. at least one specially programmed microprocessor,
f. at least one wireless transmitter,
g. a control signal; and
h. at least one non-transitory computer readable medium;
wherein the temperature sensor detects the user's body temperature;
wherein the heartrate monitor detects the user's heart rate;
wherein the at least one detector may be selected from the group consisting of a motion detector, an accelerometer, physiologic, and proximity sensor that is capable of generating the control signal indicating a possible fall or a need for help or assistance;
wherein the at least one wireless transmitter may be selected from the group consisting of a such as a Bluetooth transmitter, Wi-Fi, ISM, GSM, CDMA, 3-4-5G LTE and NFC wireless frequency; and
wherein the at least one non-transitory computer readable medium comprises computer storage media and communication media including any medium that facilitates transfer of a computer program or data from one place to another.

7. The system of claim 1, wherein the user's summoning radio transmitter, comprises:
a wearable pendant comprising;
a. at least one emergency “Help” button,
b. at least one auxiliary message function button,
c. an altimeter,
d. a GPS,
e. at least one fall detector,
f. at least one specially programmed microprocessor,
g. at least one wireless transmitter,
h. a control signal; and
i. at least one non-transitory computer readable medium;
wherein the altimeter determines the user's elevation;
wherein the GPS determines the user's location in a horizontal plane;
wherein at least one fall detector may be selected from the group consisting of a motion detector, an accelerometer, and a proximity sensor that is capable of generating the control signal indicating a possible fall or a need for help or assistance;
wherein at least one wireless transmitter may be selected from the group consisting of a Bluetooth transmitter, Wi-Fi, ISM, GSM CDMA, 3-4-5G LTE and NFC wireless frequency; and
wherein at least one non-transitory computer readable medium readable media comprises computer storage media and communication media including any medium that facilitates transfer of a computer program from one place to another.

8. The system of claim 1, wherein at least one natural-language user interface is selected from the group consisting of an Amazon Alexa, Echo, Echo Dot, Echo Show, Echo Spot, Nest, Siri, Sonos, Cortana, Google Home, Google Assistant, Simply Safe, Apple's Home Pod Home Kit, Vocca, Voice Pod, Ivee, At home Homey, Hal, Xiaomi Yee light and Jibo.

9. The system of claim 1, wherein at least one electronic communications device on a remote electronic communications device is selected from the group consisting of a PDA, phone, tablet, and iPad.

10. The system of claim 1, wherein a system associated remote annunciator is selected from the group consisting of a remotely controlled color coded flashing light, which is coordinated to reflect the specific type of emergency and housed within an externally located light fixture to garner passerby attention or summon medical personnel, a digital push message on at least one electronic communications device, and an audio push message on at least one electronic communications device.

11. The system of claim 1, wherein the at least one natural voice user interface is selected from the group consisting of a natural-language user interface to include Amazon Alexa, Echo, Echo Dot, Echo Show, Echo Spot, Nest, Siri, Cortana, Google Home, Google Assistant, Simply Safe, Apple's Home Pod Home Kit, Vocca, Voice Pod, Ivee, At home Homey, Hal, Xiaomi Yee light and Jibo.

12. The system of claim 1, wherein the Server/Cloud Service, comprises:
a. at least one Standard Communication Services;
b. at least one Cloud Speech/Voice Recognition Service; and
c. at least one Cloud Notification Push Server.

13. The system of claim 12, wherein the Cloud Speech/Voice Recognition Service further comprising a notification to be transmitted to an electronic communications device.

14. The system of claim 13, wherein the notification may be selected from the group consisting of an audible, visual, light, and text message.

15. The system of claim 12, wherein the Server/Cloud Service further comprises one or more program routines selected from the group consisting of annunciator activation, push messaging, and video imaging associated with the smart home devices pre-programmed functions.

16. The system of claim 12, wherein the Server/Cloud Service further comprises one or more program routines incorporating artificial intelligence (AI) within the video imaging associated with the smart home devices pre-programmed functions as to automatically recognize within the image of the user the need for assistance by the user and remotely summon help as determined by a User Webpage Data Access Dashboard.

17. The system of claim 1, further comprising at least one monitoring device causing the generation of a remote push message when detecting a physiologic function greater or lesser or different than a set parameter.

18. The system of claim 1, wherein the Cloud Speech/Voice Recognition Service further comprising a notification to be transmitted to a unique electronic PDA communications device as determined by a programmable display comprising a User Webpage Data Access Dashboard.

19. The system of claim 7, wherein the Cloud Speech/Voice Recognition Service further comprising a notification to be transmitted to a unique electronic PDA communications device as determined by a display comprising a User Webpage Data Access Dashboard.

20. The system of claim 1, wherein the user's summoning radio transmitter, comprises:
a wearable ring comprising;
a. at least one emergency “Help” button,
b. at least one auxiliary message function button,
c. an altimeter,
d. a GPS,
e. a temperature sensor,
f. a heartrate monitor,
g. at least one fall detector,
h. at least one specially programmed microprocessor,
i. at least one wireless transmitter,
j. a control signal; and
k. at least one non-transitory computer readable medium;
wherein the altimeter determines the user's elevation;
wherein the GPS determines the user's location in a horizontal plane;
wherein the temperature sensor detects the user's body temperature;
wherein the heartrate monitor detects the user's heart rate;
wherein the at least one an fall detector may be selected from the group consisting of a motion detector, an accelerometer, altimeter, and proximity sensor that is capable of generating the control signal indicating a possible fall or a need for help or assistance;
wherein the at least one wireless transmitter may be selected from the group consisting of a Bluetooth transmitter, Wi-Fi, ISM, GSM CDMA, 3-4-5G LTE and NFC wireless frequency; and
wherein the at least one non-transitory computer readable medium readable media comprises computer storage media and communication media including any medium that facilitates transfer of a computer data or program from one place to another.
